(19) United States
(12) Patent Application Publication
(10) Pub. No.: US 2016/0185322 A1
(43) Pub. Date: Jun. 30, 2016

(54) DEVICE FOR SUPPORTING A MOBILE DEVICE ON THE GROUND

(71) Applicant: SCHWING GMBH, Herne (DE)

(72) Inventors: Reiner Vierkotten, Oberhausen (DE); Carsten Conrad, Recklinghausen (DE); Ulrich Glawe, Gevelsberg (DE); Wolfgang Tebeek, Marl (DE); Wolfgang Merten, Marl (DE); Mykola Oleksyuk, Hattingen (DE)

(21) Appl. No.: 14/890,107

(22) PCT Filed: Mar. 11, 2014
(86) PCT No.: PCT/EP2014/054677

§ 371 Date: Feb. 11, 2016

(30) Foreign Application Priority Data
May 8, 2013 (DE) 10 2013 007 869.5

(51) Int. Cl. B60S 9/12; B66C 23/88; B66C 23/90; B66C 23/80

(52) U.S. Cl. CPC B60S 9/12; B66C 23/80; B66C 23/88; B66C 23/90

(57) ABSTRACT

A support apparatus for coupling to a vehicle, the apparatus including a support structure and a hydraulic cylinder coupled to the support structure. The hydraulic cylinder is configured to move linearly with respect to the support structure and to expand and contract. The apparatus further includes a sensing assembly that includes a proximity sensor. The proximity sensor is configured to sense and indicate that the hydraulic cylinder breaches a predetermined threshold distance between the hydraulic cylinder and the support structure.

The invention relates to a supporting device for supporting a mobile device, in particular a vehicle, on the ground.

Many utility vehicles, e.g. mobile concrete pumps, must be supported on the ground to perform certain types of work. For roadworks, work on facades, tree pruning work or other work performed by means of a boom or crane, the utility vehicle might tip over. A pump mast or a crane jib produce a high tilting moment when swung out, especially if it carries persons or loads. Supporting of the utility vehicle in such cases is mostly done by way of supporting devices in form of laterally extendable supports comprising lowerable supporting feet which establish the contact to the ground. Extending and lowering can be done hydraulically. To be able to assure stability of the support, in particular in case of a partial support according to the German standard DIN EN 12001:2012-11; Chapter 5.2.10.4.2, it is at least required to ascertain whether all supports have contact to the ground before a boom is allowed to be taken into operation.

U.S. Pat. No. 6,655,219 discloses a spring element in the supporting foot of a supporting device which is utilized to detect the supportling load. For this purpose, a strain gauge is provided at the spring element and connected to the electronic evaluator.

It is the object of the present invention to provide a device for supporting a vehicle or a mobile device on the ground, whereby a safe operation of the vehicle in an immobile status can be assured, in particular when operating a boom arm of the vehicle, which leads to tilting moments.

This object is achieved by a device according to claim 1.

Advantageous embodiments of the present invention are described in the subclaims.

The present invention proceeds from a supporting device for supporting a mobile device, in particular a vehicle, on the ground, the said device comprising
a support connected to the mobile device,
a hydraulic cylinder, which is supported on the support and which can be moved between an upper end position and a lower end position in relation to the support,
a supporting foot, which can be lowered and raised by means of the hydraulic cylinder, and
a sensing device, which produces a supporting-load-dependent signal.

A supporting device in the sense of the present invention is any device by means of which a supporting force can be introduced from a vehicle or any other mobile device into the ground above all in vertical direction. In most cases, there are four supporting devices arranged on a vehicle which together can also raise the vehicle completely from the ground and support the vehicle freely from a spring-damper-system of a wheel suspension.

According to the invention, it is proposed that the sensor unit generates the supporting-load dependent signal by means of a proximity switch which responds when the distance from the hydraulic cylinder to its upper end position falls below or exceeds a defined value.

By means of the preferably contactless working proximity switch, it is possible in a particularly simple and robust manner to detect whether a supporting force exceeding a certain threshold value acts on the supporting device. Only with a sufficiently high supporting force is it assured that the mobile device is safely supported. The threshold value can be determined through the defined distance at which the proximity switch responds. The threshold value indicates which supporting force must be available at least to exclude the risk of lifting the supporting device from the ground. In practical cases, the force threshold for truck-mounted concrete pumps, for example, lies at 300 kg. If the proximity switch detects that the threshold value is fallen short of, this situation indicates an underload case and thus, for example, an imminent tilting of the mobile device. The corresponding signal of the proximity switch can be utilized to emit an alarm signal or to interrupt the operation of a boom of the mobile device automatically or to allow only those movements of the boom which diminish the tilting moment of the machine, that means which reduce the load. It is also conceivable to retract the boom automatically in response to the signal. Likewise, the sensor system of the inventive supporting device can be advantageously utilized to assure ground contact of the support feet in accordance with the standard DIN EN 12001:2012-11 before the boom is allowed to be taken into operation.

The inventive support with a contactless proximity switch works especially reliably in relation to the detection of the ground contact, in particular in case of dirty site environments. Even with coarse contamination, the functionality is not adversely affected. At the same time, the inventive solution can be realized in a simple and cost-efficient manner.

In accordance with the present invention, the hydraulic cylinder can be mounted at an arbitrarily designed support which is connected to the mobile device, i.e. for example to the vehicle frame of a truck-mounted concrete pump, in a supporting force-transmitting manner. In a preferred embodiment, the support comprises an exterior pipe which extends along a central longitudinal axis, with the hydraulic cylinder being arranged shiftable inside the exterior pipe. With advantage, the exterior pipe in this embodiment represents a guide for the shiftable hydraulic cylinder. At the same time, the exetrior pipe protects the hydraulic cylinder.

Preferably, the proximity switch is fastened to the support, e.g. to the exterior pipe, and responds to an approach of a measuring mark arranged on the hydraulic cylinder. Alternatively, it is also possible to fasten the proximity switch to the hydraulic cylinder and to arrange the measuring mark on the support and/or exterior pipe. In principle, any contactless working proximity switch is suitable for use as proximity switch which works magnetically, electromagnetically, inductively, capacitively, optically or ultrasoncially. But it is also possible to use non-contactless working switches, pushbuttons or roller-type limit switches.

In a preferred embodiment, the hydraulic cylinder is mounted via a bearing bolt on the support, with the bearing bolt resting in bearing bores on the support and on the cylinder head of the hydraulic cylinder.

For example, at least one of the bearing bores can be designed as an oblong hole at which the hydraulic cylinder is guided along the central longitudinal axis. Hereby, a guidance of the hydraulic cylinder on the support and/or exterior pipe as well as longitudinal movability between the upper and lower end position can be realized in a simple and robust manner. Preferably, the oblong hole is arranged in the cylinder head of the hydraulic cylinder, in particular centrically in relation to the central longitudinal axis. The oblong hole ends, at which the bearing bolt arrests, define the upper and lower end position of the hydraulic cylinder in the exterior pipe. The supporting force is transmitted via the bearing bolt when the bearing bolt rests at the arrest stop of the oblong hole.

In an alternative embodiment, the bearing bolt has a non-rotation-symmetrical, preferably eccentric cross-section relative to the axis of the bearing bolt in its end sections in which it rests in the bearing bores on the support. Accordingly, the outside measure of the bearing bolt in the end sections in vertical direction can be smaller than in horizontal direction. Likewise, the bearing bolt in a central section in which it rests in the bearing bore on the cylinder head can have a non-rotation-symmetrical, preferably eccentric cross-section relative to the axis of the bearing bolt, with the outside measure of the bearing bolt in the central section in vertical direction then being smaller than in horizontal direction. The bearing bolt thus configured can be advantageously mounted in circular bearing bores on the cylinder head and/or on the support. On account of the asymmetrical shape, the inside measure of the bearing bore in vertical direction is larger than the outside measure of the relevant section of the bearing bolt so that the bearing bolt is vertically shiftable in the relevant bearing bore. The upper and lower side of the asymmetrical cross-section define the upper and lower end positions of the relative movement of the support and hydraulic cylinder. The supporting force is transmitted via the bearing bolt, when the bearing bolt rests against the upper and/or lower arrest stop of the bearing bore. The supporting device can be exposed to a substantial static load which leads to a high contact pressure of the bearing bolt in the soffit of the bearing bore. To keep the contact pressure as low as possible, the outer contour of the asymmetrical cross-section of the bearing bolt can advantageously be adapted to the inner contour of the bearing bore in those areas in which the bearing bolt rests at the soffit of the bearing bore when the support foot has been lowered. For example, with a circular bearing bore, the outer contour of the bearing bolt in the relevant area may have the same radius as the inner contour of the bearing bore.

With the asymmetric configuration of the bearing bolt in the relevant bearing areas as described before, it is of advantage if the bearing bolt is guided in torque-proof manner in the bearing bore at the cylinder head and/or in the bearing bores on the support. In this manner, the vertical shiftability of the hydraulic cylinder relative to the support is assured in a defined way.

Depending on the configuration of the inventive supporting device, the total stroke of bearing of the hydraulic cylinder relative to the support between the two end positions may be comparably small, for example it may amount to just a few millimeters. This affects the precision and reliability when generating the supporting-load-dependent signal by means of the proximity switch. To avoid this problem, a preferred embodiment of the present invention provides a gearbox co-acting with the sensor system that intensifies the stroke of the relative movement of the hydraulic cylinder and support. For example, the gearbox may be a lever gearbox comprising a lever pivoted on the support. At one point of attack, for example, the lever may be connected to the bearing bolt vertically shiftable in the bearing bores of the support, with one measuring mark being arranged at a point of the lever which is located farther away from the rotary point of the lever than the point of attack. On account of the longer lever arm, the measuring mark when shifting the hydraulic cylinder relative to the support moves stronger than the bearing bolt. The proximity switch responds to an approach of the measuring mark located on the lever and thus it detects the movement more reliably.

With a possible configuration of the inventive support, only the weight force acts as a force on the hydraulic cylinder as a force directed towards the ground.

When the support foot is raised, this force causes a lowering movement of the hydraulic cylinder relative to the support.

With an alternative embodiment of the inventive supporting device, a spring element is provided for which rests on the support and which exerts a spring force on the hydraulic cylinder that is directed towards the ground. Preferably, the spring element is mounted between a cylinder head of the hydraulic cylinder and an exterior pipe bulkhead. Preferably, the spring element is configured as a compression spring, optionally it may also be configured as a tension spring. For example, the spring element is configured as a spiral spring or cup spring, with it also being possible to provide several spring elements in combination with each other, no matter whether in series and/or in a parallel arrangement, e.g. a multitude of stacked cup springs or a multitude of spiral springs arranged within each other. For example, the spring element can be made of a metallic material or produced on a plastic basis. With further preference, several spring elements are provided for, in particular at least two spring elements, which are arranged side by side or one behind the other between the hydraulic cylinder and the exterior pipe bulkhead. The spring force and/or pretension of the spring element can be adjustable in order to be able to variably pre-determine the load threshold at which the inventive ground contact sensor system responds.

With special preference, the inventive supporting device comprises another spring element, with the spring elements being arranged in a double-pipe guidance about the central longitudinal axis. Hereby, a coupling of several spring elements can be realized in a simple and robust manner. The spring elements can be arranged independently of each other and be guided individually through one of the two inner shell areas of the double-pipe guidance. In accordance with an advantageous embodiment, the supporting device comprises another sensor facility which produces a signal when the support foot is raised. Conventional supporting devices in most cases comprise a sensor system which detects whether the support foot has been raised. The signal from this sensor system can be utilized, for example, in order to assure in driving mode of the vehicle that all support feet have been raised. This further sensor facility can be integrated into the inventive concept in order to improve safety still further. For example, if the (logically inverted) signal of the further sensor facility indicates that the support foot has not been raised, it means by inverse conclusion that the support foot has been lowered (at least partially). In accordance with the present invention, the operation of a boom can then be made dependent on whether the signal from the proximity switch of the first sensor facility signalizes a sufficient support load and whether the signal from the further sensor facility signalizes at the same time that the support foot has not been raised. This redundancy increases safety.

In accordance with an advantageous embodiment, the inventive supporting device comprises a control facility which is suitably configured to control a boom of the mobile device dependent on the signal from the sensor facility. For example, a vehicle equipped with an inventive supporting device may comprise an actuator to actuate a boom which is coupled to the control facility of the supporting device. Hereby, the operation of the boom of the vehicle can be released automatically, released partially or be blocked.

With a vehicle, e.g. a truck-mounted concrete pump, equipped with an inventive supporting device, each of the (typically four) supporting devices is expediently provided with a cross girder which relative to the vehicle can be laterally extended or swung-out, in particular hydraulically. Lateral extendability or swivability is indispensable in order to enhance the supporting area beyond the vehicle width (permitted under traffic law).

Practical examples of the present invention are described in greater detail in the following by way of drawings where:

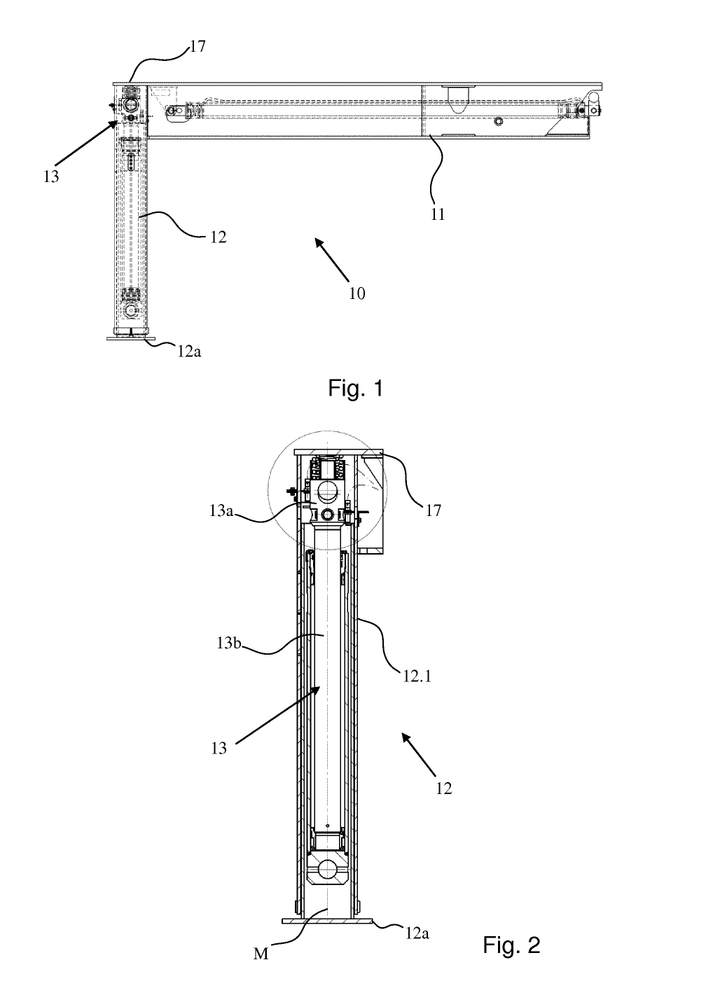

FIG. 1 in a side view shows a supporting device according to a practical example of the present invention in retracted status;

FIG. 2 in detail in a side view shows a support of the supporting device illustrated in FIG. 1;

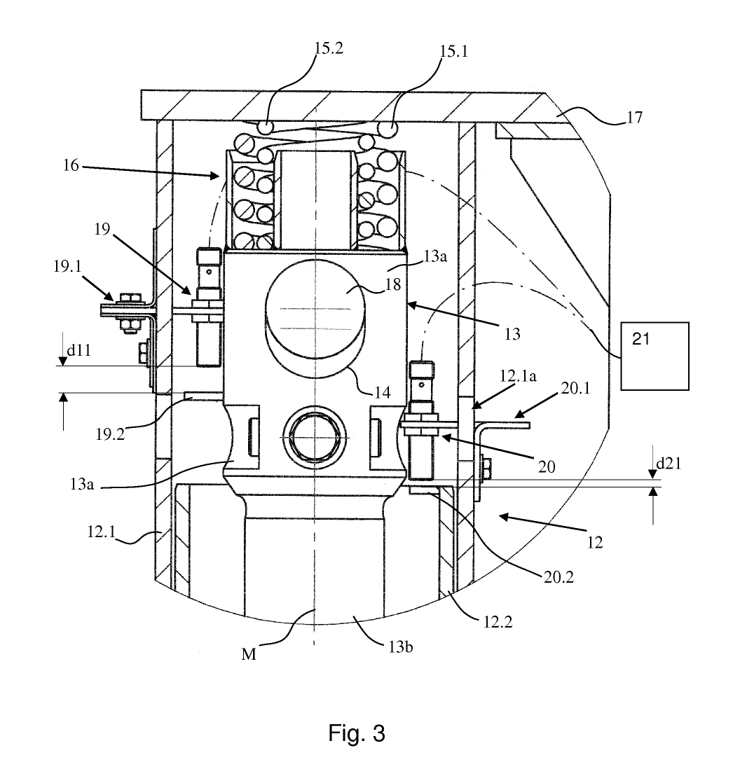

FIG. 3 in detail in a side view shows an exterior pipe and a hydraulic cylinder arranged therein of the support illustrated in FIG. 2;

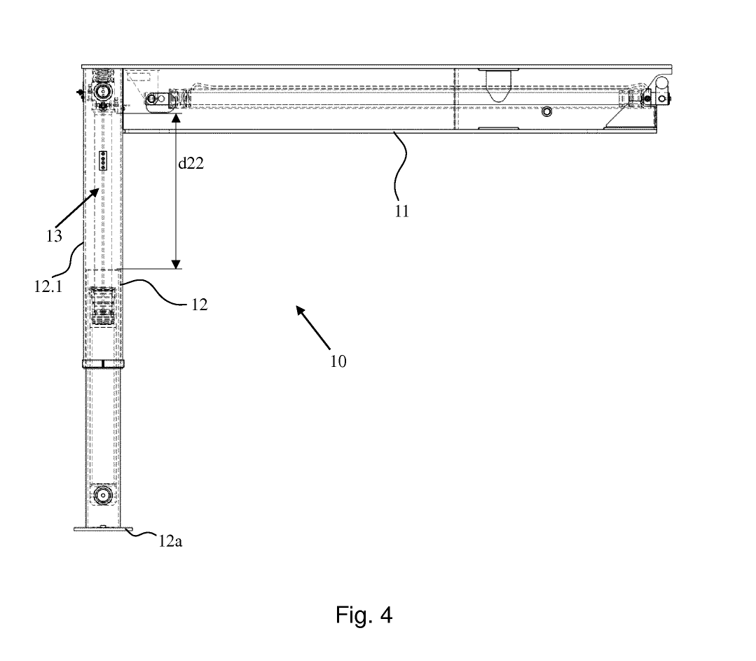

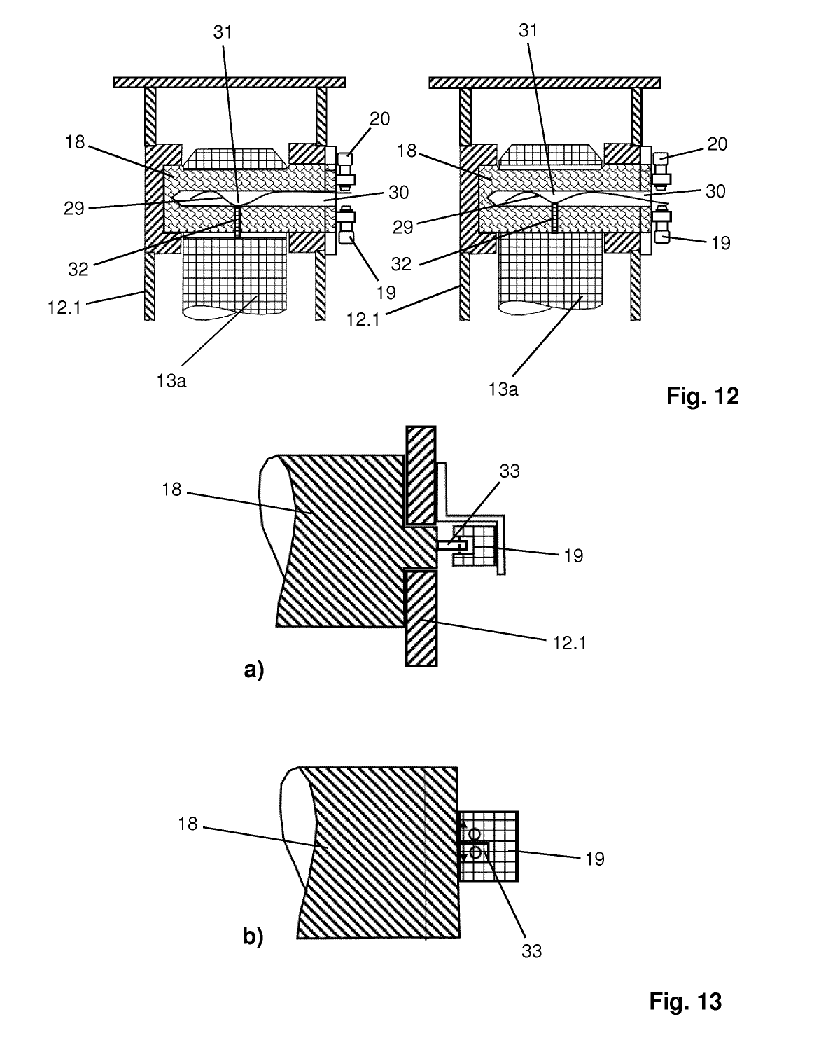

FIG. 4 in a side view shows the supporting device illustrated in FIG. 12 with the support being in extended status;

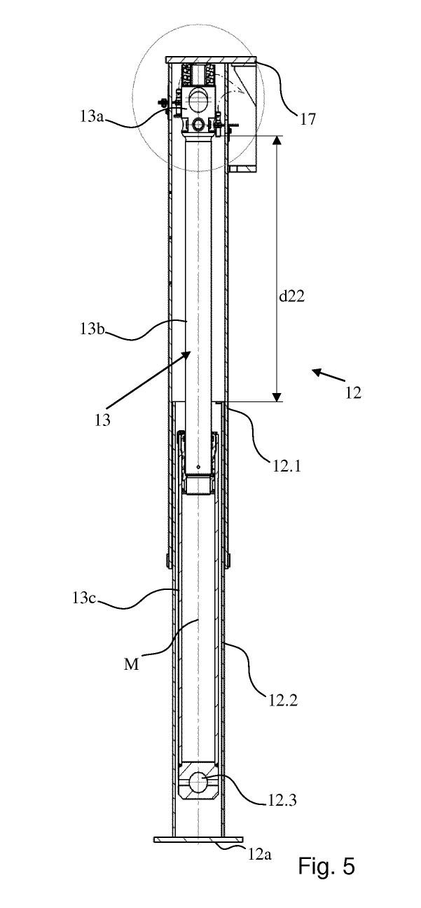

FIG. 5 in detail in a side view shows the extended support of the supporting device illustrated in FIG. 4; and

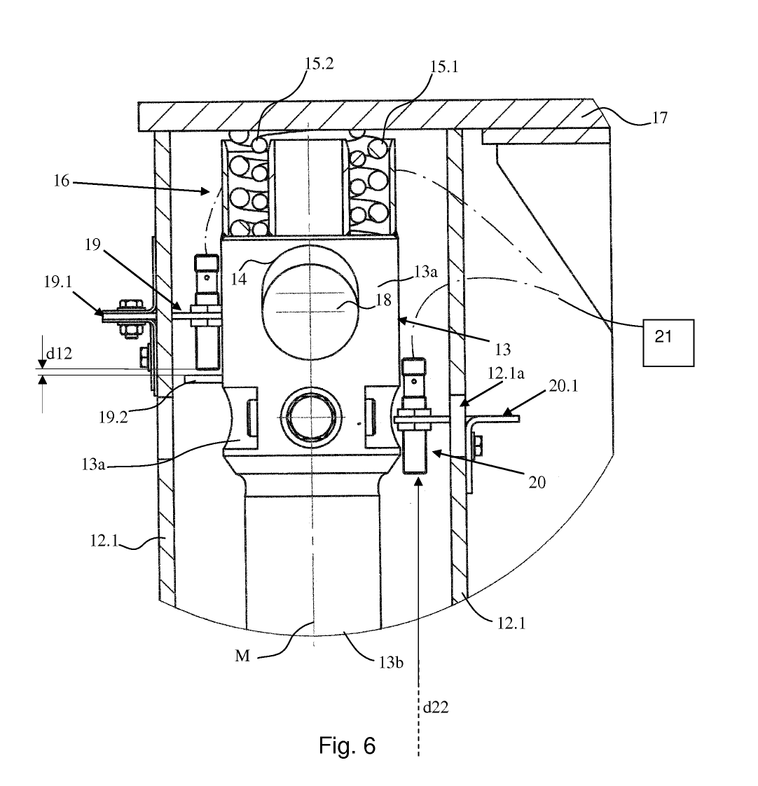

FIG. 6 in detail in a side view shows the exterior pipe and the hydraulic cylinder arranged therein, with the support being in extended status;

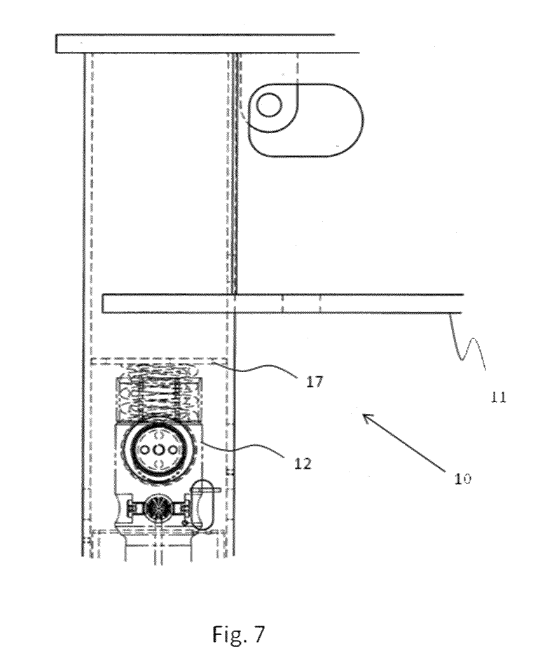

FIG. 7 in detail shows another practical example with an alternative arrangement of the supporting device at the boom;

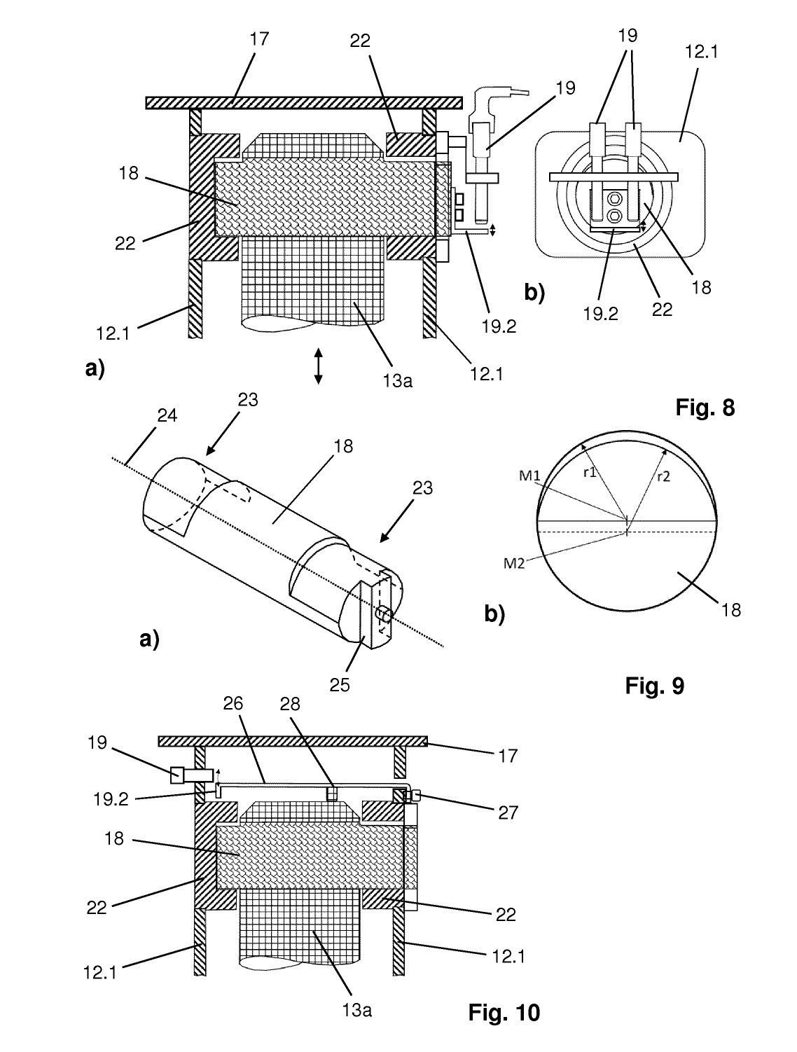

FIG. 8 in detail in a side view shows the exterior pipe with the hydraulic cylinder arranged therein in accordance with another practical example with an eccentric bearing bolt;

FIG. 9 shows the bearing bolt with eccentric end sections;

FIG. 10 in detail in a side view shows the exterior pipe with the hydraulic cylinder arranged therein in accordance with another practical example with an eccentric bearing bolt and gearbox to intensify the stroke movement;

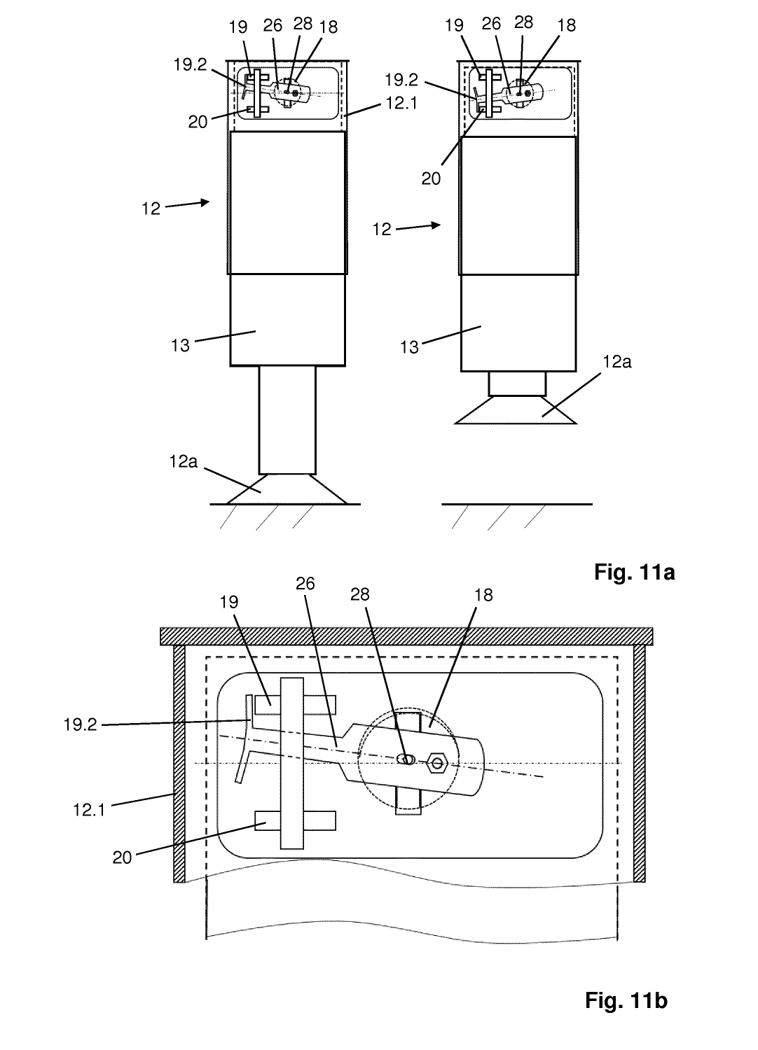

FIG. 11 shows a lateral view of another practical example of the inventive support with gearbox to intensify the stroke movement;

FIG. 12 in detail in a side view shows the exterior pipe with the hydraulic cylinder arranged therein in accordance with still another practical example;

FIG. 13 in detail in a top view and a side view shows a shiftable bearing bolt in accordance with another practical example with light-sensitive barriers acting as proximity sensor.

FIG. 1 shows a supporting device 10 which comprises a cross girder 11 as well as a support 12 with a support foot 12a and a hydraulic cylinder 13 arranged in support 12. Cross girder 11 is coupled to a non-illustrated vehicle or to any other mobile device and it can be extended laterally.

FIG. 2 shows the support 12 which extends along a central longitudinal axis M. Hydraulic cylinder 13 comprises a cylinder head 13a and a piston rod 13b, with the cylinder head 13a resting and/or supported on a lid 17 of support 12. Support 12 comprises an exterior pipe 12.1 which is connected to the lid 17. As shown by FIG. 1, the lid 17 is formed by part of the cross girder 11 and it forms an exterior pipe bulkhead at one end of exterior pipe 12.1. For example, lid 17 may consist of a metal plate.

FIG. 3 illustrates the arrangement of the exterior pipe 12.1 relative to lid 17 and to the bearing of the hydraulic cylinder 13 in the exterior pipe 12.1. Cylinder head 13a comprises an oblong hole 14 through which a bearing bolt 18 is guided, with the bearing bolt 18 being fastened in the exterior pipe 12.1. Instead of an oblong hole, for example in case of a cylinder head with a hollow bore, the cylinder head 13a may have two oblong holes at its outer shell surface. Relative to the bearing bolt 18, cylinder head 13a is movably guided in the oblong hole 14. At one upper end of cylinder head 13a, a double-pipe guidance 16 is provided for in which two spring elements 15.1, 15.2 are arranged, in particular two cylindrical helical springs arranged within each other, thereof one being guided inside at an inner pipe of the double-pipe guidance 16 and the other one being guided inside at an outer pipe of the double-pipe guidance 16. The double-pipe guidance 16 is configured as a pipe-in-pipe arrangement. Spring elements 15.1, 15.2 are arranged towards each other at a radial distance, hence they do not touch each other. Both spring elements 15.1, 15.2 rest on the cylinder head 13a and lid 17. Spring elements 15.1, 15.2 are compression springs which cause the cylinder head 13a to shift downwards and to being arrested at an upper stop of oblong holes 14 as long as there is no ground contact of the support foot 12a.

Arranged within the exterior pipe 12.1 is a sensor facility 19 in form of a proximity switch which is fastened by means of fastening means 19.1 at the outside on exterior pipe 12.1. The sensor facility 19 is directed towards a measuring mark 19.2 which is fastened at cylinder head 13a and which protrudes laterally from cylinder head 13a. In the status shown here without ground contact, the relevant distance d11 is maximal. The proximity switch responds, i.e. it changes its switching status when the distance between proximity switch and measuring mark 19.2 falls below and/or exceeds a certain value. Thereby, the sensing device 19 finally responds to the distance of the hydraulic cylinder 13 from its upper end position.

The support 12 can be extended downwards by shifting an inner pipe 12.2 relative to the outer pipe 12.1 downwards by means of the hydraulic cylinder 13. To detect the retracted position of the inner pipe 12.2, a second sensor facility 20, also in form of a proximity switch, is provided within the exterior pipe 12 which responds to an approach of a measuring mark 20.2 fastened to the inner pipe 12.2. In the retracted status shown here, the relevant distance d21 is minimal. The second sensor facility 20 is fastened by means of fastening means 20.1 to the exterior pipe 12.1. The fastening means 20.1 are configured as a T-shaped angle plate which is guided through an opening 12.1a of the exterior pipe.

The sensor facilities 19, 20 are connected to a control facility 21 which is suitably configured to control one or more function(s) of a vehicle (not shown here) depending on the switching conditions of the sensing devices 19, 20, i.e. depending on detected distances d21 and d11. In particular, the function of a boom is only released if the sensing device 19 detects that the distance d11 falls below a defined value and that distance d21 at the same time exceeds a defined value.

FIG. 4 shows support 12 in extended status in which distance d22 evidences a larger amount than in the retracted status. Support foot 12a has been shifted downwards versus exterior pipe 12.1.

FIG. 5 in detail shows that the inner pipe 12.2 is guided in the exterior pipe 12.1 and laterally stabilized, and that a cylinder pipe and/or extendable telescope section 13c of hydraulic cylinder 13 is fastened via a fastening bolt 12.3 to the inner pipe 12.2. The supporting force is transmitted from support foot 12a to the inner pipe 12.2 and to the cylinder pipe and/or extendable telescope section 13c, and from there via the piston rod 13b and bearing bolt 18 to the exterior pipe 12.1.

As shown in FIG. 6, the cylinder head 13a rests with the lower end of oblong hole 14 against bearing bolt 18. Both spring elements 15.1, 15.2 are compressed. In other words, there is contact to the ground by way of which a sufficiently high force is exerted on the piston rod 13b so that both spring elements 15.1, 15.2 are compressed. The distance d12 between the measuring mark 19.2 and the ground contact sensor facility 19 in this status is minimal. The shifting path of cylinder head 13a relative to bearing bolt 18 corresponds to the amount by which the length of the oblong holes 14 is greater than the diameter of the oblong holds and bearing bolt 18, respectively.

In FIGS. 1-6, the upper area of the supporting boom at the same time forms the plate 17 at which spring 15 and/or springs 15.1 and 15.2 find support. FIG. 7 shows an alternative to this arrangement in which the cover plate 17 is arranged deeper within the support boom.

FIG. 8 in detail in a side view shows another practical example. As illustrated in FIG. 8a, bearing bushings 22 are connected to the exterior pipe 12.1 which accommodate the bearing bolt 18 in bearing bores. Moreover, bearing bolt 18 rests in a bearing bore at cylinder head 13a of hydraulic cylinder 13.

FIG. 9a shows a three-dimensional view of bearing bolt 18 in a possible configuration. In its end sections 23, in which it rests in the bearing bores on support 12, bearing bolt 18 is turned-off so that it has the non-rotation-symmetrical, i.e. eccentric cross-section illustrated in FIG. 9b relative to axis 24 of bearing bolt 18. As illustrated in FIG. 9b, the bolt has a radius r1 viewed from the center M1 of the bolt, and in the turned-off area 23 it has a radius r2 viewed from a center M2 lying at a certain distance thereunder, with radius r1 being equivalent to radius r2. Radius r1 and/or radius r2 corresponds to the radius of the circular bearing bore. Thereby, the bearing bolt 18 is vertically shiftable in the bearing bushings 22 and the hydraulic cylinder 13 receives its vertical movability as indicated by a double arrow in FIG. 8a.

The upper and lower side of the asymmetrical cross-section of bearing bolt 18 define the upper and lower end positions of the relative movement of support 12 and hydraulic cylinder 13. In order to keep the contact pressure of bearing bolt 18 at the inner soffits of bearing bores under load as low as possible, in particular to avoid a linear force introduction, the outer contour of bearing bolt 18, as described hereinabove, in the turned-off end sections 23 is adapted to the inner contour of the relevant bearing bore. Bearing bolt 18 is torque-proof guided at the support 12. This purpose is served by a guidance projection 25 with vertical guidance areas. As shown in FIGS. 8a and 8b, a measuring mark 19.2 is arranged at one end of bearing bolt 18, the shifting movement of this measuring mark relative to support 12 being registered redundantly by means of two proximity switches 19 in order to produce a support load-dependent signal in the sense of the present invention when the distance of the hydraulic cylinder 13 to its upper end position falls below or exceeds a defined value. The two proximity switches 19 can also be positioned opposite to each other, i.e. above and below measuring mark 19.2 in order to further increase measuring safety and redundancy because then the two proximity switches each receive a different measuring signal.

As one may gather from FIG. 8, the total stroke of shifting of the hydraulic cylinder 13 relative to support 12 between the two end positions in the illustrated practical example is comparably small. It just amounts to a few millimeters. This affects accuracy and reliability on producing the support load-dependent signal by means of proximity switches 19. To improve accuracy and reliability of detection, the practical example illustrated in FIG. 10 provides for a gearbox co-acting with the proximity switch 19 which intensifies the stroke of the relative movement of hydraulic cylinder 13 and support 12. The gearbox is a lever gearbox with a lever 26 in form of a beveled plate that is fastened by means of a screw 27 to the exterior pipe 12.1. On account of its elastic properties, lever 26 can be rotated around its pivot point at exterior pipe 12.1. The stroke movement is transferred by the cylinder head 13a at a point of attack 28 to lever 26. At the end of lever 26 which is farther away from the pivot point of the lever than the point of attack 28, a measuring mark 19.2 is arranged whose movement is detected by means of proximity switch 19. On account of the longer lever arm, the measuring mark 19.2 when shifting the hydraulic cylinder 13 moves stronger relative to support 12 than in the practical example shown in FIG. 8. The proximity switch 19 responds to an approach of the measuring mark 19.2 arranged at lever 26 and thus it detects the movement more reliably. To increase measuring safety/redundancy, it would be possible here, too, to use a second proximity switch below proximity switch 19 which detects cylinder head 13a additionally in a non-raised status.

An alternative configuration with a gearbox to intensify the stroke of the relative movement is shown in FIG. 11. Illustrated in FIG. 11a on the left side is the support 12 with a lowered support foot 12a and on the right side with a raised support foot 12a. Used in this practical example as done in the practical examples illustrated in FIGS. 8 to 10 is the eccentric bearing bolt 18 having the configuration shown in FIG. 9. Bearing bolt 18 according to the practical example shown in FIG. 8, in deviation from the representation in FIG. 9, has two threaded bores at its front end in the guidance projection 25 for fastening the measuring mark 19.2, whereas the bearing bolt in FIG. 9a has a point of attack 28 at the guidance projection 25. The gearbox is a lever gearbox comprising a lever 26 pivoted on the exterior pipe 12.1, with the lever 26 at the point of attack 28 being connected to the bearing bolt 18 vertically shiftable in the bearing bores of support 12. A measuring mark 19.2 is arranged at the end of lever 26. It approaches the upper proximity switch 19 (shown at left) when lowering the support foot 12a and the lower proximity switch 20 (shown at right) when raising the support foot 12a. Lowering the support foot 12a in this practical example can be detected reliably (redundantly) when, as shown at left in FIG. 11a, the upper proximity switch 19 detects the approach of measuring mark 19.2 and generates a corresponding signal, while at the same time the lower proximity switch 20, from which the measuring mark 19.2 is away, generates no signal. For better recognizability, FIG. 11b in detail shows the gearbox with the lowered support foot 12a according to the representation at left in FIG. 11a.

In the practical example shown in FIG. 12, the bearing bolt 18 in a central section in which it rests in the bearing bore at the cylinder head 13a comprises a cross-section which is eccentric relative to the axis of bearing bolt 18. In the area of the bearing bore at cylinder head 13a, the bearing bolt is turned-off at the top side so that it results a cross-section there which corresponds to the cross-section of the bearing bolt 18 in the end sections as shown in FIG. 9. The vertical shiftability of hydraulic cylinder 13 relative to support 12 here results from the shiftability of the bearing bolt 19 in the bearing bore at cylinder head 13a. In the practical example of FIG. 12, too, a gearbox is provided for intensifying the stroke of the relative movement. It comprises a laminated spring 29 which is bent twofold or several times (three times in this practical example) along its longitudinal extension and which rests with its bending points on the inner wall of an axial bore 30 in bearing bolt 18. The end of the laminated spring 29 protrudes from the bore 30 at one end of bearing bolt 18 and it serves as measuring mark whose movement is registered by means of two proximity switches 19, 20 lying opposite to each other relative to the laminated spring 29. Acting on the laminated spring 29 at a point of attack 31 in the interior of bore 30 is a plunger 32 guided radially in bearing bolt 18. With the support foot 12a being raised (shown at left), gravity moves the hydraulic cylinder 13 and thus cylinder head 13a downwards. Plunger 32 is correspondingly extended downwards.

Laminated spring 29 assumes a shape in which the free end of laminated spring 29 maximally approaches the upper proximity switch 20. With the support foot 12a being lowered (shown at right), the cylinder head 13a is moved upwards, whereby the plunger 32 is slided into bearing bolt 18. This causes the laminated spring 29 to deform so that its free end utilized as measuring mark maximally approaches the lower proximity switch 19. Based on the signals of the oppositely responding proximity switches 19, 20, lowering and setting-down of the support foot 12a on the ground can be detected reliably and redundantly.

In the practical example shown schematically in FIG. 13, a light-sensitive barrier is utilized as proximity switch 19. FIG. 13a shows a top view while FIG. 13b shows a side view. Connected to the bearing bolt 18 configured, for example, in the manner shown in the practical examples of FIGS. 8 to 11, is a blocking element which in the upper end position of the hydraulic cylinder 13 and thus of bearing bolt 19 blocks an upper light beam path 34 and which in the lower end position blocks a lower light beam path 35 of the light-sensitive barrier so that the relevant end positions are reliably detectible.

1-16. (canceled)

17. A support apparatus for coupling to a vehicle, the apparatus comprising:
a support structure;
a hydraulic cylinder assembly coupled to the support structure, the hydraulic cylinder assembly configured to move linearly with respect to the support structure and to expand and contract; and
a sensing assembly comprising a proximity sensor, the proximity sensor configured to sense and indicate that the hydraulic cylinder assembly breaches a predetermined threshold distance between the hydraulic cylinder assembly and the support structure.

18. The apparatus of claim 17, further comprising:
a control unit communicatively coupled to the proximity sensor, the control unit configured to receive an indication that the hydraulic cylinder assembly has breached the predetermined threshold.

19. The apparatus of claim 18, further comprising:
a base support coupled to the hydraulic cylinder assembly; and
a sensor, separate from the proximity sensor, coupled to the base support, the sensor configured to sense a position of the base support.

20. The apparatus of claim 19, wherein the control unit is configured to block operation of a vehicle when the control unit receives an indication from the proximity sensor that the hydraulic cylinder assembly has breached the predetermined threshold and receives an indication from the sensor that the base support has not been raised.

21. The apparatus of claim 17, wherein the hydraulic cylinder assembly is positioned within the support structure.

22. The apparatus of claim 21, wherein the hydraulic cylinder assembly is coupled to the support structure by a spring.

23. The apparatus of claim 17, further comprising:
a cross-girder coupled to the support structure and configured to couple to a vehicle.

24. The apparatus of claim 17, wherein the proximity sensor is one of a magnetic, electromagnetic, inductive, capacitive, optical, and ultrasonic sensor.

25. The apparatus of claim 24, wherein the proximity sensor is directly attached to the hydraulic cylinder assembly.

26. The apparatus of claim 24, wherein the proximity sensor is directly attached to the support structure.

27. The apparatus of claim 24, wherein the proximity sensor is a contactless sensor.

28. The apparatus of claim 17, wherein the proximity sensor indicates that the hydraulic cylinder assembly breaches a predetermined threshold distance between the hydraulic cylinder assembly and the support structure when hydraulic cylinder assembly exceeds the predetermined threshold.

29. The apparatus of claim 17, wherein the proximity sensor indicates that the hydraulic cylinder assembly breaches a predetermined threshold distance between the hydraulic cylinder assembly and the support structure when hydraulic cylinder assembly falls below the predetermined threshold.

30. A method for use with a vehicle-support assembly, the vehicle-support assembly including at least one support structure coupled to a hydraulic cylinder assembly that is configured and arranged to move linearly with respect to the support structure, the method comprising:
detecting, using a proximity sensor, a distance between the hydraulic cylinder assembly and the support structure;
determining that the distance has breached a predetermined distance; and
in response to such determination, outputting a signal indicating that a vehicle is susceptible to tilting.

31. The method of claim 30, further comprising:
in response to such determination, emit an alarm signal.

32. The method of claim 30, further comprising:
in response to such determination, interrupt operation of the vehicle.

33. The method of claim 30, further comprising:
in response to such determination, retract a vehicle's boom.

34. The method of claim 30, further comprising:
in response to such determination, only permit a vehicle to perform operations that mitigate the vehicle's susceptible state.

35. A support apparatus for coupling to a vehicle, the apparatus comprising:
a support structure;
a hydraulic cylinder assembly coupled to the support structure, the hydraulic cylinder assembly configured and arranged to move linearly with respect to the support structure; and
proximity sensing means for sensing that the hydraulic cylinder has breached a predetermined threshold distance between the hydraulic cylinder and the support structure.
